(19) United States
(12) Patent Application Publication
(10) Pub. No.: US 2024/0232938 A9
(43) Pub. Date: Jul. 11, 2024

(54) METHOD AND SYSTEM FOR IMPROVING TIME SERIES FORECASTING WITH MISSING AND NOISY DATA

(71) Applicant: Verizon Patent and Licensing Inc., Basking Ridge, NJ (US)

(72) Inventors: Howard Mizes, Salem, SC (US); Daniel Abreu, San Jose, CA (US); Kaiss K. Alahmady, Plano, TX (US)

(73) Assignee: Verizon Patent and Licensing Inc., Basking Ridge, NJ (US)

(21) Appl. No.: 17/969,957

(22) Filed: Oct. 20, 2022

(51) Int. Cl. G06Q 30/02; G06Q 10/04

(52) U.S. Cl. CPC G06Q 30/0246; G06Q 10/04

(57) ABSTRACT

The present teaching relates to impression count determination. A forecasting time series (TS) model is established based on measured impression counts (MI-counts). Metrics are calculated from MI-counts from a sub-range of a profile. Different types of data characteristics are detected based on the metrics. Hybrid correction applied to the profile is determined based on the detected data characteristics. Corrected impression counts (I-counts) for the profile are generated via the hybrid correction operation based on the MI-counts and I-counts estimated from the forecasting TS models and provided for determining a level of viewership of the content at the site.

### BACKGROUND

An advertiser whose advertisement is displayed on a billboard may pay a price determined based on the number of impressions to an audience near the billboard. In some situations, the number of impressions or a count of a number of people who had a chance to view the content displayed may be estimated. For instance, the number of impressions of an advertisement displayed on a billboard may be estimated based on the number of people in vehicles passing nearby the location of the billboard. The number of people in vehicles near a billboard can be estimated from smartphone triangulation data.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates measured impression counts in relation to a time series model that may be used for imputation;

FIG. 1B shows an exemplary measured impression count profile with some data missing at random in relation to a corresponding time series model;

FIG. 1C shows an exemplary noisy profile of measured impression counts in relation to a corresponding time series model;

FIG. 1D shows an exemplary measured impression count profile with some anomalously low impression counts in relation to a corresponding time series model;

FIG. 2A depicts an exemplary high level system diagram of a framework for determining impression count (I-count) based on measured I-count and a forecasting time series model in a hybrid mode, in accordance with an embodiment of the present teaching;

FIG. 2B is a flowchart of an exemplary process of a framework for determining impression count (I-count) based on measured I-count and a forecasting time series model in a hybrid mode, in accordance with an embodiment of the present teaching;

FIG. 3A depicts an exemplary high level system diagram of a hybrid I-count determiner, in accordance with an embodiment of the present teaching;

FIG. 3B shows exemplary types of profile metrics, in accordance with some exemplary embodiment of the present teaching;

FIG. 4A is a flowchart of an exemplary process for the hybrid I-count determiner, in accordance with an embodiment of the present teaching;

FIG. 4B is a flowchart of an exemplary process of obtaining flags for different situations determined based on profile metrics, in accordance with an embodiment of the present teaching;

FIG. 4C is a flowchart of an exemplary process for generating replacement labels based on flags for different situations, in accordance with an exemplary embodiment of the present teaching;

FIG. 5A illustrates an exemplary intermediate solution via imputation to obtain an I-count based on a forecasting time series model, in accordance with an exemplary embodiment of the present teaching;

FIG. 5B is a flowchart of an exemplary process of an intermediate solution unit to derive an I-count based on exemplary imputation conditions, in accordance with an exemplary embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching is directed to improving time series forecasting to derive impression counts in a hybrid mode based on profile metrics obtained from measured impression counts. Details related to the hybrid mode in estimating impression counts will be disclosed below. In some embodiments, the measured impression counts are obtained with respect to a site, which can be a billboard or a wall space, where some content (such as advertisement) is displayed and viewable by others near the site. An impression count associated with a particular site may be measured with respect to a time unit such as an hour, over a period of time such as a day. The impression count may be measured by counting the number of people who are near the site within each time unit. For instance, the impression count in an hour with respect to a billboard along the east bound of a highway may be estimated based on the number of people in vehicles passing through the billboard viewshed within the hour when traveling east bound on the highway. In some embodiments, the billboard viewshed may be defined as a geographical region centered around the billboard within which a user is considered to have an unobstructed view of the billboard at an angle and distance that the content on the billboard is readable. An example includes a semi-circle area in front of a billboard that spans 60 degrees in each direction from the center, with a total span of 120 degrees without any obstructions within that space up to a radial distance of 600 m from the billboard. The number of people in vehicles within the viewshed of a billboard may be estimated from position (optionally also velocity) inferred from location-tracking techniques such as radio or GPS triangulation.

In estimating the number of impressions with respect to a site, a communication service provider may be able to do so based on logged locations of its customers, which may then be used to estimate the overall impression count (I-counts) of the entire population by extrapolating the impression count from the service provider according to its market share. For instance, for a particular billboard, a communications service provider A may estimate the I-counts of the site based on registered locations of its customers. If the local market share of service provider A is 30%, then the overall I-counts for the site from the entire population may be estimated by scaling up (e.g., I-counts/0.3) or extrapolating the I-counts based on the known market share. The market share distribution at each locale may differ based on the locale or the market share in the home location of the customer, so that the market I-counts determined this way are adaptive to the market share distribution in each locale and each home location of the customer.

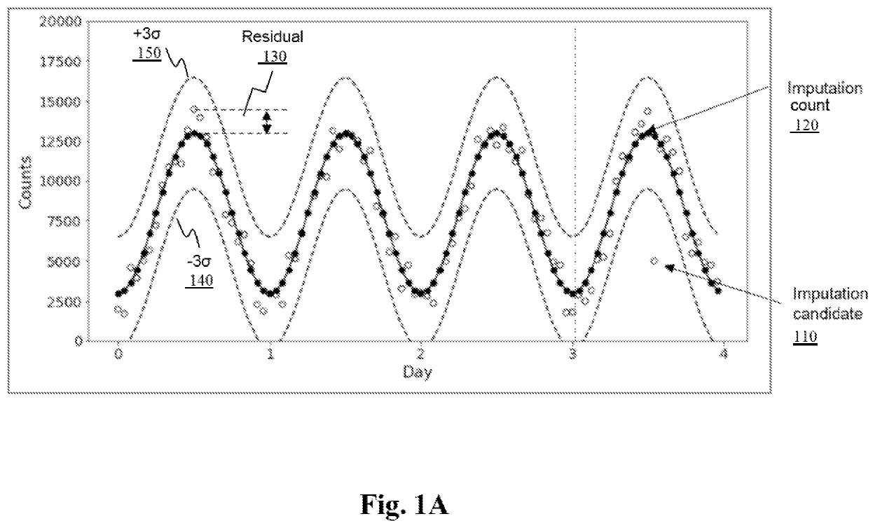

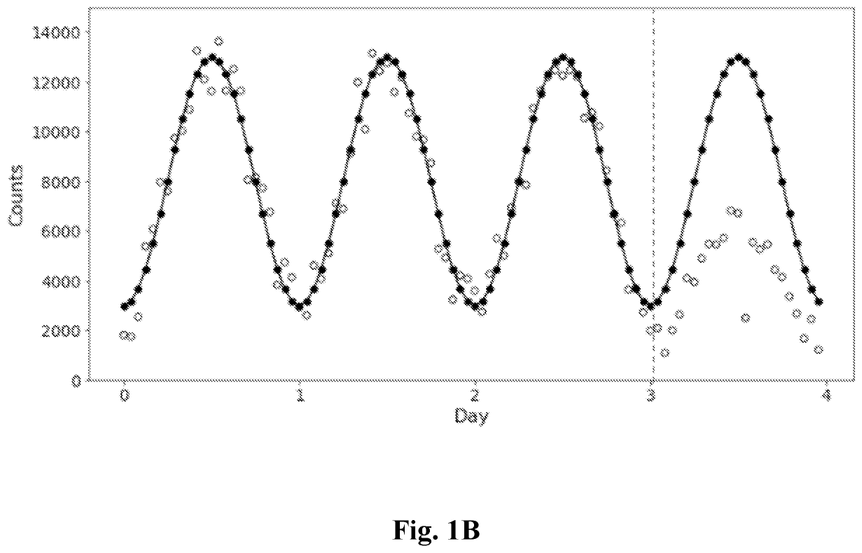

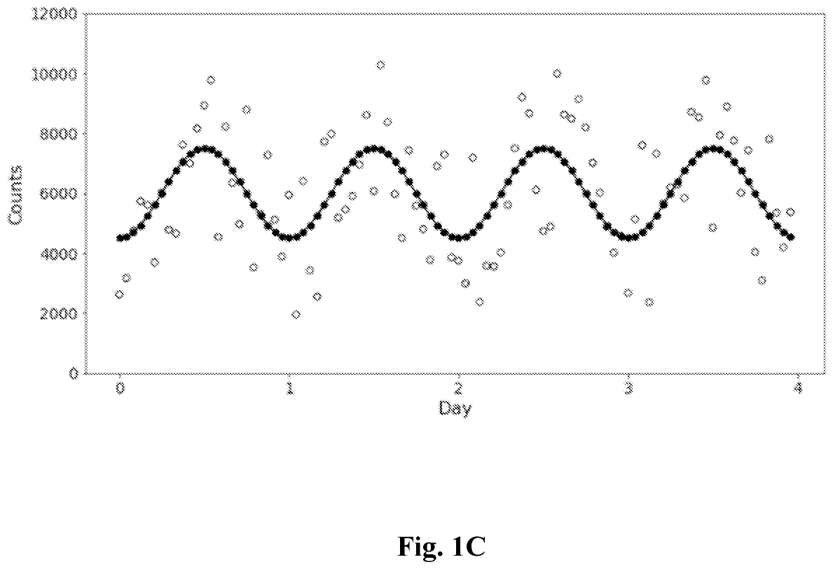

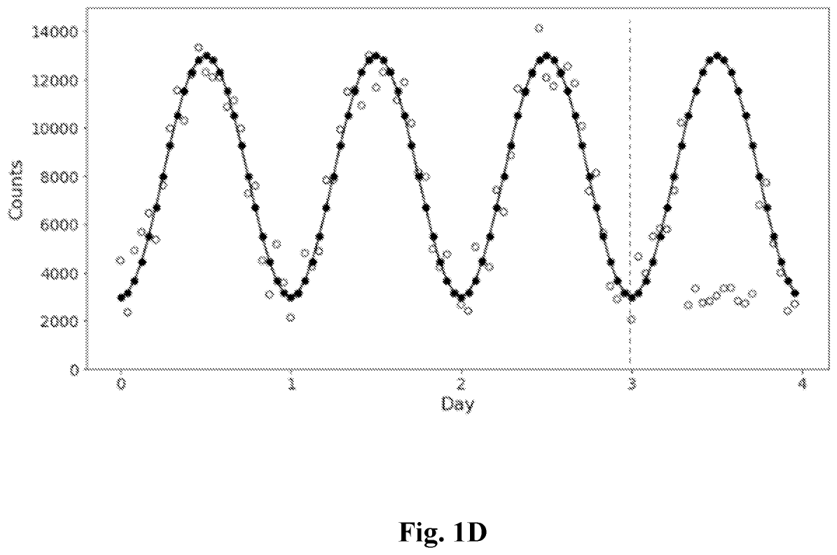

FIG. 1A illustrates plots with measured I-counts represented by hollow circles with respect to a site, collected over several days, where the X axis denotes time (days), and the Y axis denotes I-count value, and the granularity of the counts is at an hour interval. Based on the measured I-counts, a time series model may be obtained by fitting the measured data with a time series model, which is also plotted in FIG. 1A with points on the time series model represented by solid circles. A time series model may be used to predict, e.g., numbers of products to be sold each day, number of customer calls to a call center each day, or number of impressions related to an advertisement displayed at a site. Time series have been used for modeling time-dependent data patterns to capture various effects such as periodic behavior at a daily, weekly, or yearly time scale, trends, and changepoints.

Smartphone location data can sometimes be inconsistently captured and logged. Such inaccuracies may impact the ability to correctly estimate the I-counts. Thus, in some situations, corrections to the measured I-counts may be needed. In some respects, correction comprises: 1) recognizing a situation where a correction is needed, and 2) determining a specific correction scheme to be applied that is appropriate for the recognized situation. To recognize a situation where correction is needed, residuals between measured and a corresponding estimated I-counts, such as example 130 shown in FIG. 1A, may be processed for all pairs of measured and time series modeled points to derive statistics such as a standard deviation or a, which may be used to formulate a condition for detecting the situation for correction. As illustrated in FIG. 1A, a dotted curve 140 represents a lower bound set at −3σ of residuals and a dotted curve 150 represents an upper bound at +3σ of residuals. These bounds may serve as a boundary of detecting when correction is needed. For instance, if a measured I-count falls outside of this boundary, a correction is needed, as shown in FIG. 1A. In FIG. 1A, the measured I-count 110 is outside of the [−3σ, +3σ] range, and therefore this scenario is identified as a candidate for correction. A measured I-count to be corrected may be replaced with another I-count, e.g., estimated from corresponding time series (TS) model. This is illustrated in FIG. 1A where an impression count estimated using the time series model is used to replace the measured I-count 110.

Other criteria may also be defined for detecting a situation for correction. In some embodiments, a measured I-count is to be corrected if it is 3σ less than the model predicted I-count and 50% smaller than the model predicted I-count. These exemplary conditions are formulated based on individual I-count values measured at different time instances so that they may not be able to capture any characteristics of data patterns that extend over a period of time (e.g., in several hours or in a day). In addition, when hard thresholds are used without identifying specific data characteristic type, correction based on such an individual I-count based scheme may result in inconsistent correction results for I-counts having the same type of underlying data characteristics. So, reliably recognizing that multiple I-counts involved in the same data characteristic pattern is crucially important. The present teaching detects different correction situations based on profile metrics, obtained from a profile with multiple I-counts to capture persistent characteristics associated with different types of data patterns. Based on detected data patterns, the present teaching then determines correction schemes based on characteristics associated with different types of data patterns. Details about the profile metrics-based detection of correction situations will be provided below.

The second task is related to how to correct measured I-counts associated with a detected type of data failure. As illustrated in FIG. 1A, a predictive time series forecasting model may be utilized for correcting measured I-counts. However, as discussed herein, in some situations, merely replacing individual measured I-count using an estimated I-count from a time series model may not be adequate for consistently correcting all I-counts experiencing the same type of data failure. Corrections to I-counts under the same type of data characteristic pattern need to be determined consistently with respect to the underlying characteristics of data detected. The present teaching provides a hybrid scheme for correction, i.e., depending on the type(s) of data characteristics detected from a profile, different corrections are applied.

FIGS. 1B-1D illustrate several exemplary types of data failure. The first exemplary type of data failure is shown in FIG. 1B in the last portion (after the dotted vertical line) of the plot, where a data profile exhibits data characteristics caused by impression missing at random. The second exemplary type of data characteristics is due to noisy impressions as shown in FIG. 1C, where the measured I-counts (hollow circles) exhibit a pattern dominated by randomness. The third exemplary type of data characteristics relates to anomalously low impression counts, as shown in FIG. 1D, where the last portion of the measured I-counts (the hollow circles after the dotted vertical line) have consistently unusually low counts. Other types of data characteristics may also exist. Some of the characteristic patterns of data may signify some type of data failure and some may merely represent the observed data from each site.

Each of these exemplary data situations exhibit different characteristic patterns which may call for corrections appropriate for each specific situation. For the second task associated with correction, the present teaching discloses an adaptive approach to dynamically determine how to correct measured I-counts in a profile according to the types of data characteristics detected based on profile metrics computed from the profile data.

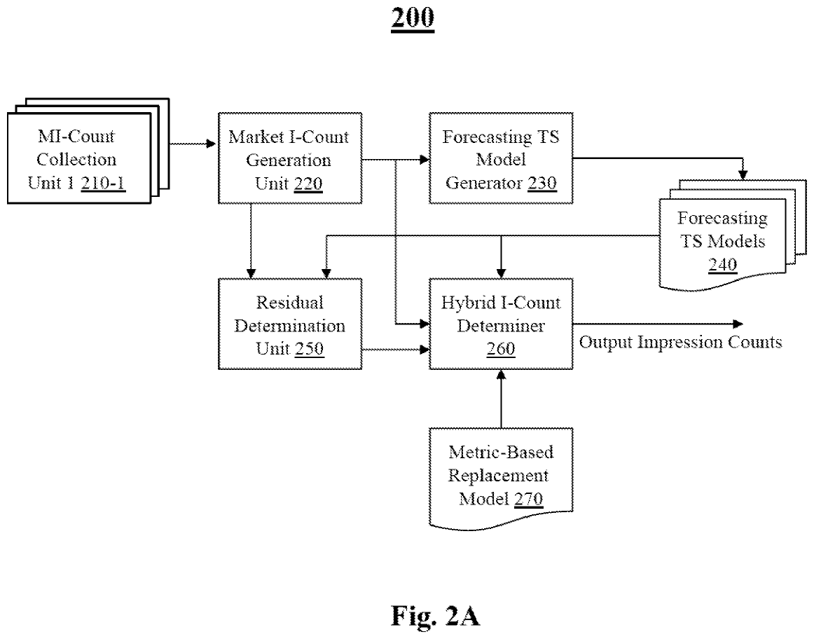

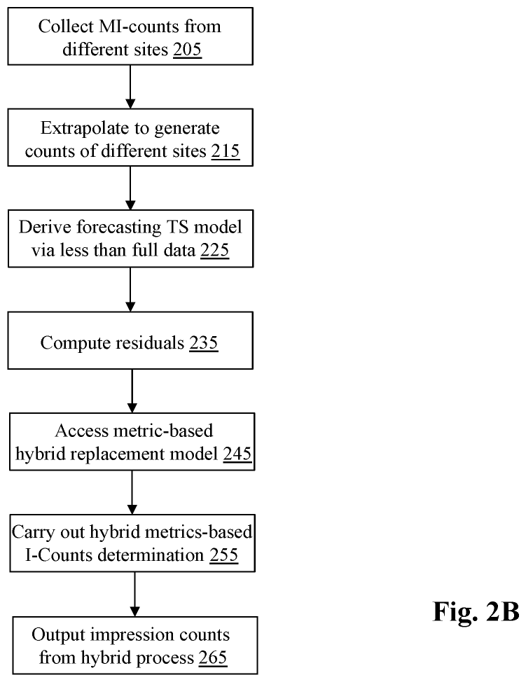

The present teaching is directed to improving the quality of impression counts associated with content displayed on a display site. Specific aspects of the present teaching relate to detecting different types of data characteristics based on metrics computed from profile data and then based on specific type(s) of detected characteristics to carrying out correction appropriate for the detected types of data pattern. FIG. 2A depicts an exemplary high level system diagram of a framework 200 for determining profile I-counts using hybrid correction based on profile metrics, in accordance with an embodiment of the present teaching. Framework 200 collects measured I-counts from different sites, generates forecasting time series models for these sites accordingly, and then makes corrections to measured I-counts in corresponding profiles (e.g., in the last section of the collected measured I-counts) via hybrid correction in accordance with the present teaching. In this illustrated embodiment, the framework 200 comprises a plurality of measured impression count (MI-count) collection units 210, each of which may be responsible for collecting MI-counts from a corresponding site for a single smartphone provider's customers, a market I-count generation unit 220 for extrapolating from a single phone provider customers to all smartphone customers to derive market I-counts, a forecasting time series (TS) model generator 230 for generating a forecasting TS model for each site, a residual determination unit 250 for computing the residuals for each site, and a hybrid I-count determiner 260 that generates I-counts for different sites via hybrid correction operation.

As discussed herein, the impression counts with respect to each site may differ, e.g., because the crowd gathering patterns around different sites may be different, the forecasting TS model for each site is established based on the I-counts from that specific site in order to capture the characteristics specific to the site. As shown in FIG. 2A, there may be separate MI-count collection units for collecting measured I-counts from different sites, including, e.g., collection unit 210-1 for collecting measured I-counts from the first site, a collection unit 210-2 for collecting the same from a second site, etc. In some embodiments, there may have a single MI-count collection unit 210 responsible for collecting measured I-counts from all sites. In this case, data from each individual site may need to be stored and utilized separately.

As discussed herein, in some situations, MI-counts collected from a site may not represent the overall impression volume with respect to the site. A service provider, such as a wireless smartphone service carrier, may estimate the impression volume associated with a site based on registered home location data of its customers. Then the service provider's known market share may be used to estimate the overall impression volume of the site by, e.g., scaling up or extrapolating the collected MI-count data volume according to known market share information. For example, if a wireless phone carrier has a market share of 50%, then the MI-count volume estimated by the carrier with respect to a specific site may be doubled (scaled up according to the market share) to come up with the total market population for the site as an estimate of the entire market. This approach may be applied to each site so that the overall estimated I-count volume may adapt to the market share distribution of each locale and the home location of the customers that visit this locale. The market I-count generation unit 220 is provided to take collected MI-counts for each site and generate an overall market I-count via, e.g., extrapolation based on market share information associated with the geographical region around the site.

The total population of I-count for each site derived via extrapolating may then be used to develop a forecasting TS model for that site. Different forecasting models may be used, including, without limitation, statistical models and machine learned forecasting models. Statistical models may include, e.g., Moving Average, Exponential Smoothing, Box-Jenkins, Drift Method, Naive Method, multiple linear regression, autoregressive integrated moving average (ARIMA), seasonal autoregressive integrated moving average (SARIMA), and autoregressive integrated moving average with explanatory variable (ARIMAX). In some applications, machine learning may also be used to derive a forecasting TS model based on, e.g., training data related to each site. These time series models may be univariant, bivariant, or multivariant. It is understood that these exemplary forecasting TS models are merely for illustration purposes instead of as limitations. Any other forecasting timeseries models appropriate may also be used.

Based on the extrapolated market I-counts from different sites, the forecasting TS model generator 230 generate a forecasting TS model for each site. This yields a plurality of forecasting TS models 240, each of which is for a corresponding site, which captures the characteristics of the impression patterns related to each site and may be used to estimate or forecast I-counts. As discussed herein, discrepancies exist between market I-counts and a corresponding forecasting TS model. Such residuals may be used to determine how a measured I-count may be corrected. The residual determination unit 250 is provided for computing, respectively, residuals between the measured and estimated I-counts for each site.

The hybrid I-count determiner 260 in FIG. 2A is provided to detect, with respect to each site, type(s) of data characteristics that may be present at a site and if so, produce corrected I-counts that are improved as to quality and accuracy when compared with measured I-counts. As discussed herein, specific data characteristics associated with a profile (its I-counts are subject to correction) may be detected based on metrics computed from the profile data associated with a site and, accordingly, a correction scheme to be applied to each measured I-count in the profile may be determined in accordance with some pre-set metric-based replacement model stored in 270.

FIG. 2B is a flowchart of an exemplary process of the framework 200 for determining impression counts (I-counts) via hybrid correction for each site based on measured I-counts collected and a forecasting time series model, in accordance with an embodiment of the present teaching. The MI-count collection unit(s) 210 may obtain, at 205, MI-counts associated with different sites over a period of time (e.g., one week). With the billboard example, the MI-counts for each billboard may be determined, e.g., based on registered locations of mobile devices traveling by the billboard. At different times, the same mobile device may be attributing to MI-counts associated with different billboards. A mobile device as discussed herein may include, without limitation, a smartphone, a smartwatch, a tablet, personal data assistant (PDA), a laptop, or any other form of handheld devices whose locations may be tracked.

Each MI-count associated with a site may be aggregated with respect to a pre-defined time unit (e.g., every hour), determined, e.g., by a total number of viewers appearing within a certain distance of the site. An MI-count associated with a specific site (e.g., a billboard) may be stamped with a time (e.g., a particular hour of a specific day). Thus, MI-counts associated with a site form a sequence with the MI-counts arranged in accordance with their corresponding times. Each of the MI-counts for each site may then be used to generate, at 215, the market I-counts for the site via, e.g., extrapolation to obtain a sequence of market I-counts for the site. At 225, each market I-counts sequence for a site may then be utilized, by the forecasting TS model generator 230, to derive a corresponding forecasting TS model for the site.

In some embodiments, some of the market I-counts associated with a site may be excluded from being used to establish a forecasting TS model. For example, the market I-counts in a profile subject to correction may not be used to derive the forecasting TS model. For instance, the I-counts from the last day of a collection period may form a profile that is subject to correction so that they may not be used for deriving a TS model. This is illustrated in FIGS. 1B and 1D where I-counts in the last day exhibit unusual data pattern and inclusion of such data in deriving the TS model may lead to inaccurate or even misleading models. In another example, I-counts to be excluded may not be consecutive, e.g., I-counts associated with, e.g., weekend days. In some embodiments, the TS models may be derived based on all I-counts data, e.g., when the I-counts is collected over an extended period of time so that a small amount of data irregularity may not impact the ability of the models to capture the overall characteristics of the impression patterns. The forecasting TS models generated for different sites are then stored in 240.

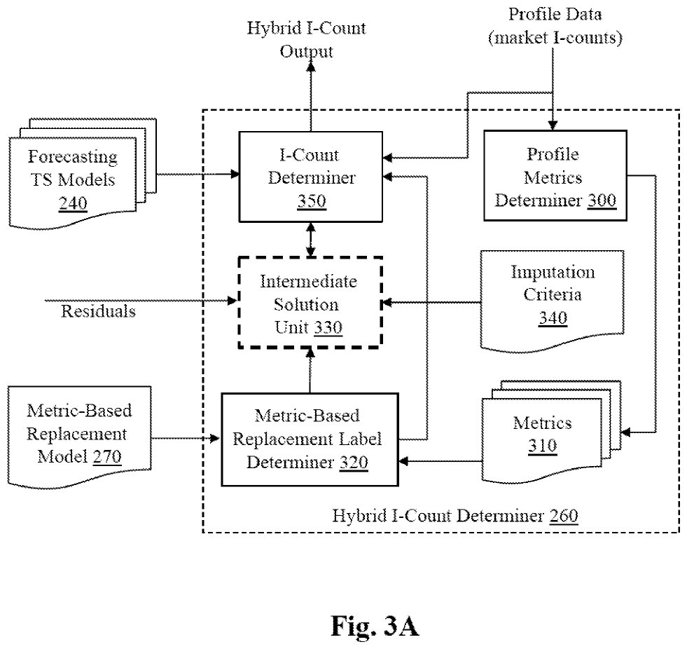

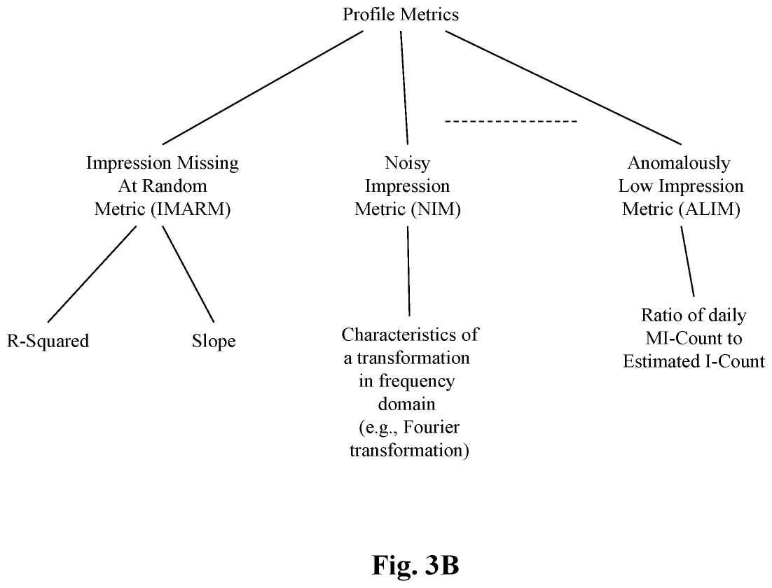

As discussed herein, residuals between measured and estimated (from forecasting TS models) I-counts may play a role in detecting situations where corrections may be needed. To facilitate that, the residual determination unit 250 may be invoked to compute, at 235, residuals for each site between market I-counts and corresponding I-count values from the TS model. The market I-counts, the corresponding forecasting TS model, and residuals computed for each site may then be input to the hybrid I-count determiner 260. Based on these inputs, the I-count determiner 260 may access, at 245, a metric-based replacement model 270 to compute certain metrics for detecting different types of data characteristics and then carries out, at 255, hybrid correction to the profile data before it outputs, at 265, the corrected I-counts. Details related to the hybrid I-count determiner 260 are provided below with reference to FIGS. 3A-5B.

FIG. 3A depicts an exemplary high level system diagram of the hybrid I-count determiner 260, in accordance with an embodiment of the present teaching. In this exemplary embodiment, the hybrid I-count determiner 260 comprises a profile metrics determiner 300, a metric-based replacement label determiner 320, an I-count determiner 350, and optionally an intermediate solution unit 330. In operation, the hybrid I-count determiner 260 determines, with respect to profile data having I-counts of a defined time period (e.g., last day) from a site, whether correction is needed, if so, how to correct the I-counts in the profile, and then generate the output I-counts (either measured or corrected). As discussed herein, the hybrid correction scheme operates based on metrics computed from the profile data. In some embodiments, the forecasting TS model for a site may be derived without using the I-counts in the profile, e.g., the I-counts of the last day that are subject to correction determination.

The profile metrics determiner 300 receives profile data and computes different profile metrics therefrom. Such computed profile metrics characterize certain properties of the I-counts in the profile and may be used to detect different types of data characteristics that may give rise to a need for correction. FIG. 3B shows exemplary types of profile metrics, in accordance with some exemplary embodiment of the present teaching. As discussed herein, metrics are computed to characterize data patterns that may indicate certain types of data failure. The exemplary metrics illustrated in FIG. 3B include, but not limited to, metric related to impression miss at random (IMARM), metric related to noisy impressions (NIM), . . . , and a metric related to anomalously low impressions (ALIM).

A profile may be described based on its characteristics, which may be captured via metrics. For example, metric IMARM characterizes a profile distribution where impression counts are missing at random and quantifies the strengthen of the characteristics. Metric NIM may characterize the random nature or noisiness of a profile and indicate the level of noisiness. Metric ALIM may characterize the situation that impression counts in a profile are anomalously low. There may be other types of data patterns with various characteristics, and each may be captured and quantified using corresponding characterizing metrics. For each profile, one or more metrics may be computed for detecting one or more types of data characteristics and the specific metric(s) to be used may be determined based on nature of the application in hand.

Depending on the data properties at issue, a statistical metric may be formulated so that the targeted properties in profile data representing a specific type of characteristics may be captured. For example, IMARM may be formulated to detect the level of correlation between the measured and the estimated I-counts in a period of, e.g., one day. If the measured impressions for each hour of the latest 24-hour interval is taken as the independent variable, and the estimated impressions for each hour of the latest 24-hour interval is taken as the dependent variable, then the R-squared formulation may be adopted to measure the correlation. The p-value may also be used as a statistical measure to discern if there is a relation between the independent variable (measured I-counts) and dependent variable (estimated I-counts). Typically, a p-value less than 0.05 may be used as a threshold to identify existence of a correlated relationship. As another example, the slope of a line fit between the estimated and measured impressions may increase from 1.0 (one) when the fraction of missing impressions increases from zero.

With respect to ALIM, its computation may be designed to capture situations where impressions are inconsistently reported or not reported at all at, e.g., hourly intervals. To reflect that, metric ALIM may be, e.g., defined as the ratio of the measured daily impressions to the estimated daily impressions. With respect to NIM, it may be designed to be high if the profile data exhibits the characteristics as shown in FIG. 1C, where the measured I-count values may be dominated by random variations and not dominated by a periodic signal. NIM may be formulated for capturing the random characteristics of a profile where unpredictable residuals dominate the period features and the trends captured by a forecasting TS model. An exemplary NIM may be defined that transforms the time series of a profile to the frequency domain such as by a Fourier transform. For profiles with a highly repeatable daily signal, e.g., visits are high during the day and drop at night, the transformed Fourier series profile likely has a peak at 1 cycle/day compared to the amplitude at other frequencies. For profiles that have a low daily repeatability, this peak likely is small or absent compared to the amplitude at other frequencies.

With respect to a transformed Fourier profile, the day-to-day variability may manifest itself as white noise. Such a feature may be captured by averaging the Fourier amplitudes from a quarter of the Nyquist frequency to the Nyquist frequency. The amplitude at 0 cycles/day may have a much higher impressions averaged across the time series. In some embodiments, NIM may be formulated using the following definition:

$$V = ( \frac{4}{n} {\sum }_{i = n / 4}^{i = n / 2} {f}_{i} ) / f ( n / 24 )$$

where V denotes the noisy impression metric, n denotes the number of points in the time series profile at an hour granularity, and f corresponds to a vector of n points of the absolute value of the Fourier transform of the time series profile. Different definitions for these exemplary metrics may also be used so long as the characteristics of the underlying types of data failure can be captured.

The metrics as discussed herein may then be used by the metric-based replacement label determiner 320 to determine what types of data pattern are present in the profile. To rely on such computed metrics to recognize each type of data pattern, certain thresholds or conditions may be defined in terms of metric values with respect to each type of data pattern so that an assessment of whether metrics satisfy conditions related to each type of data pattern can be carried out in order to decide whether each type of data pattern is present in the profile. For example, with respect to data pattern with characteristics due to impression missing at random, assuming that R-squared and slope metrics are used, then thresholds with regard to the values of R-squared and slope may be provided so that if the values of the metrics exceed the thresholds, it is deemed that the data pattern associated with impression missing at random situation does exist. As discussed herein, in some embodiments, the threshold for R-squared may be set at 0.7 and the threshold for slope may be set at 1.2; the condition for detecting this type of data pattern may be that both metrics R-squared and slope are larger than 0.7 and 1.2, respectively. So, when the calculated R-squared is larger than 0.7 and the calculated slope is larger than 1.2, then the data characteristics attributed to impression missing at random is detected. In some embodiments, other conditions may also be incorporated to define data characteristics caused by impression missing at random. For example, when p-value is also used, a threshold for the p-value to be set at 0.05 and detection condition may be added that the p-value also needs to be below 0.05 in order to detect the situation associated with data missing at random.

Similarly, in some embodiments, the threshold for anomalously low impression metric may be set at 0.3 and the condition for detecting the anomalously low impression data situation may be defined as metric <0.3. Furthermore, the threshold for noisy impression metric may be set at 0.025 and the condition to detecting a data pattern associated with noisy impressions may be defined as that the noisy impression metric is larger than 0.025. These thresholds and the accordingly defined conditions enable the detection of different types of situations associated with specific data characteristics.

In some embodiments, thresholds set in relation to different metrics in conditions for detecting different types of data patterns may be specified by, e.g., a subject matter expert upon examining the profiles in different types of data situations and the characteristics of the metrics computed from such profiles. In some embodiments, machine learning may be used to learn such thresholds based on training data including, e.g., profiles with data pattern types classified (labeled as ground truth) and corresponding metrics computed therefrom. With machine learning, thresholds for different metrics with respect to different types of data characteristics may be learned so long as the classification of the data pattern type is labeled as such.

As discussed herein, the need for correction may arise when certain type(s) of data characteristics is detected from a profile. The specific correction to be applied may be determined according to how many types and in what combination of different types of data patterns are recognized from the profile data. In some embodiments, based on the detected type(s) of data situation, a correction label may be set according to some preset criteria, e.g., specified by a metric-based replacement model 270. For instance, the metric-based replacement model 270 may define that if anomalously low impression type of data characteristics is detected, then all measured I-counts in the profile may be replaced with the estimated I-counts from the forecasting TS model.

The replacement label set according to the detected type(s) of data pattern may dictate that impacted I-counts are to be corrected in a certain way. For instance, the replacement label may be set “full,” indicating that all measured I-counts in a profile from a site are to be replaced with the estimated I-counts from a corresponding forecasting TS model for the site. If the replacement label is set “none,” it may instruct that none of the measured I-counts in the profile is to be replaced. With these two replacement label values, the measured I-counts in the profile may be handled in the same way (either no replacement for all or replacement for all). Optionally, the replacement label may also be set “intermediate solution” when the conditions for “full” and “none” are not met. With an “intermediate solution,” it may indicate a correction mode in which, instead of all I-counts are handled the same way, the correction with respect to each I-count is assessed and carried out individually depending on whether the value of the measured I-count satisfies some preset conditions. In some embodiments, the “intermediate solution” correction mode may be implemented using an imputation approach as discussed herein. In this case, statistics (such as standard deviation a) of residuals between measured and estimated I-counts may be used to define a condition under which a measured I-count is to be corrected.

According to the set replacement label, the I-count determiner 350 is invoked to generate a hybrid I-count output according to the value of the replacement label (set by the metric-based replacement label determiner 320). As discussed herein, when the label is either “none” or “full,” the I-count determiner 350 performs correction on all profile I-counts uniformly, i.e., either retain the measured I-counts when the label is “none” or the I-counts estimated from the forecasting TS model 240 if the replacement label is “full”. The hybrid I-count output is generated by the I-counter determiner 350 in these two correction modes.

Optionally, when the replacement label is set “intermediate solution”, the I-count determiner 350 may activate the intermediate solution unit 330 to perform correction on individual I-count in the when certain condition is met by the I-count. When the intermediate solution is implemented using imputation, whether correction is needed for each measured I-count may be assessed against the imputation criteria stored in 340. In some embodiments, the imputation criteria 340 may be defined based on statistics associated with residuals between measured I-counts and TS model estimated I-counts. In this case, the intermediate solution unit 330 may receive residuals from the residual determination unit 250 (as shown in FIG. 2A) as input. The individually corrected I-count is then sent to the I-count determiner 350 as the hybrid I-count output.

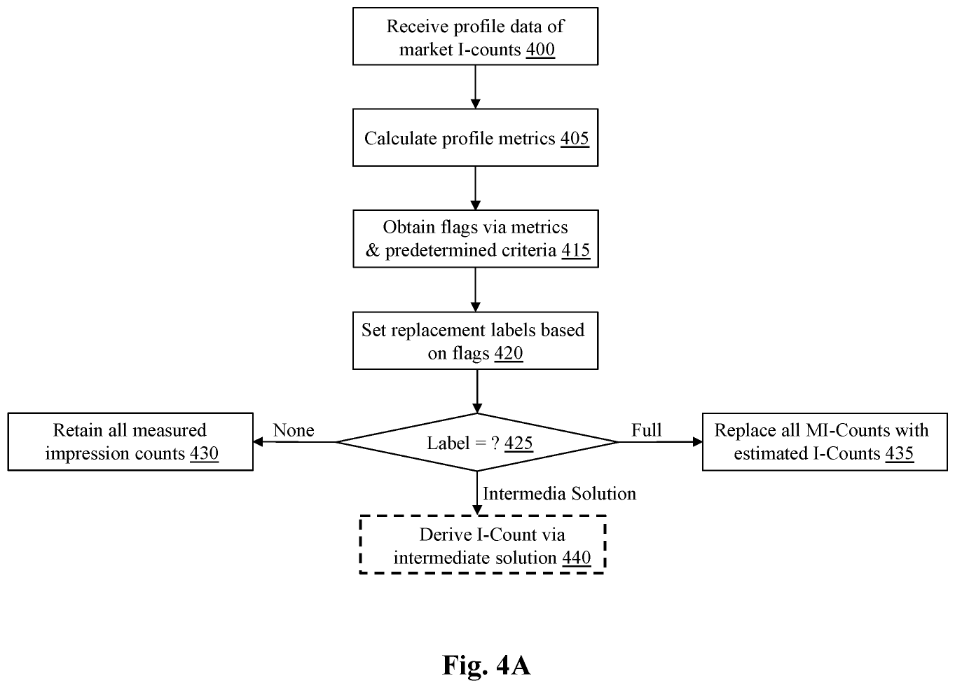

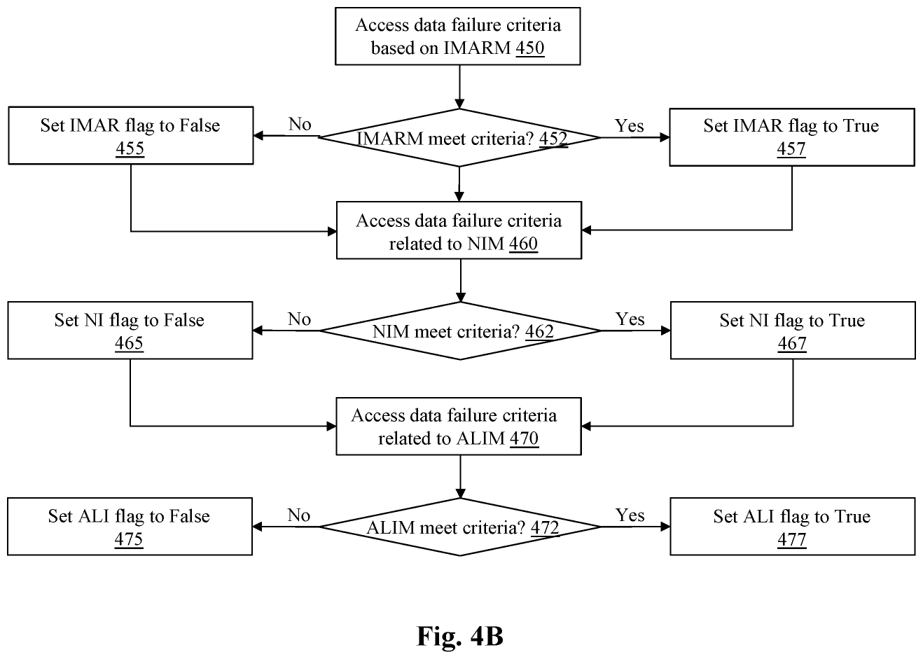

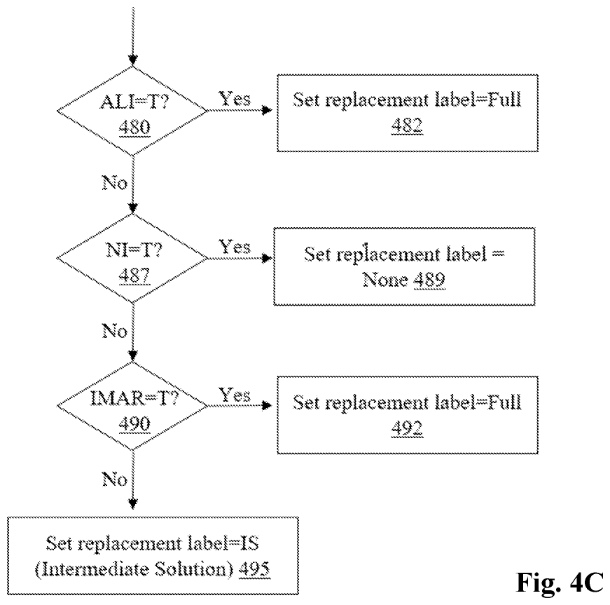

FIG. 4A is a flowchart of an exemplary process for the hybrid I-count determiner 260, in accordance with an embodiment of the present teaching. When the profile metrics determiner 300 receives profile data at 400, it calculates one or more profile metrics at 405 and stored the metrics in 310. Based on the profile metrics, the metric-based replacement label determiner 320 first sets, at 415, flags associated with different types of data characteristics in accordance with some predetermined criteria. The detected types of data characteristics are then used to set, at 420, the replacement label in accordance with the metric-based replacement model 270. Details related to how to set flags associated with different types of data characteristics and then determine the replacement label are provided with reference to FIGS. 4B-4C.

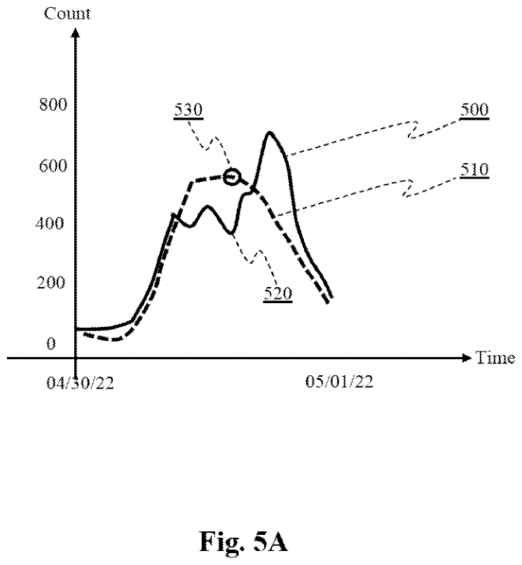

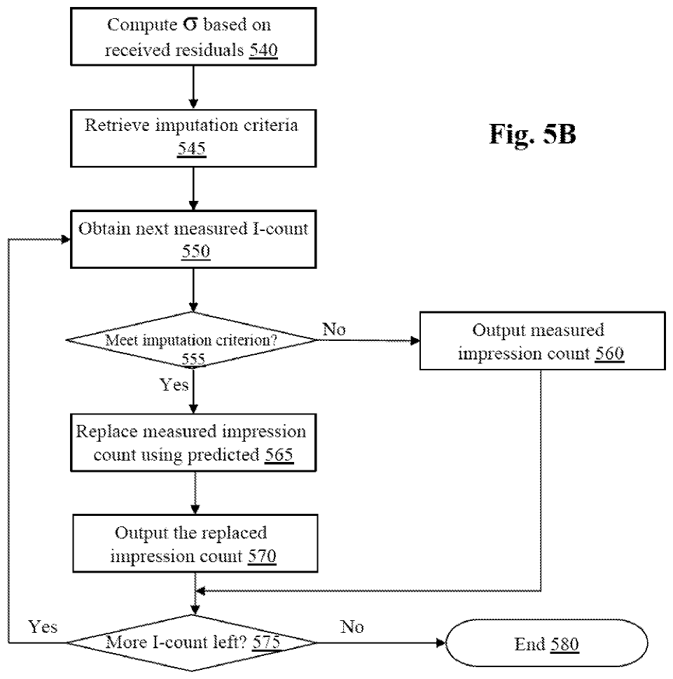

Once the replacement label is set, the I-count determiner 350 is activated to perform correction on the profile data in accordance with the replacement label. As illustrated in FIG. 4A, for example, when the replacement label is set “full,” determined at 425, the I-count determiner 350 replaces all measured I-counts in the profile using corresponding estimated I-counts from the forecasting TS model as the hybrid I-count output. If the replacement label is set “none,” the I-count determiner 350 retains the measured I-counts in the profile as the hybrid I-count output (without correction). In some embodiments, the replacement label may be set “intermediate solution” indicating to handle correction on each measured I-count individually to derive the hybrid I-count output. In this case, the I-counter determiner 350 invokes the intermediate solution unit 330 to handle correction under the “intermediate solution” mode to derive, at 440, the hybrid I-count output. Details related to correction under an exemplary intermediate solution via imputation are provided with reference to FIGS. 5A-5B.

FIGS. 4B-4C are flowcharts of exemplary processes of the metric-based replacement label determiner 320 for determining the type(s) of data characteristics detected based on metrics and setting the replacement label according to the type(s) of data characteristics detected. Specifically, FIG. 4B is a flowchart of an exemplary process of setting flags corresponding to different types of data characteristics based on profile metrics, in accordance with an embodiment of the present teaching. In this illustrated embodiment, upon being activated, the metric-based replacement label determiner 320 accesses, at 450, IMARM and criteria set to detect the presence of an impression missing at random situation based on IMARM. Some of the criteria for detecting IMARM were provided herein based on, e.g., R-squared, slope, and p-value. If the calculated IMARM satisfies the criteria for impression missing at random, determined at 452, the impression missing at random (IMAR) flag is set to True at 457. Otherwise, the IMAR flag is set to False at 455. To set the flag for noisy impression, the metric-based replacement label determiner 320 accesses, at 460, NIM calculated from the profile and the criteria set to detect the presence of a noisy impression situation based on NIM. If the profile NIM satisfies the criteria for noisy impression, determined at 462, the noisy impression (NI) flag is set to True at 467. Otherwise, the NI flag is set to False at 465. Furthermore, to set the flag for anomalously low impression type of data characteristics, the metric-based replacement label determiner 320 accesses, at 470, the ALIM calculated from the profile and the criteria set to detect the presence of an anomalously low impression situation based on ALIM. If the profile ALIM satisfies the criteria for anomalously low impression, determined at 472, the anomalously low impression (ALI) flag is set to True at 477. Otherwise, the ALI flag is set to False at 475. The set flags are indicative of the type(s) of data characteristics detected from the profile.

FIG. 4C is a flowchart of an exemplary process for determining a replacement label based on flags indicative of detected types of data characteristics, in accordance with an exemplary embodiment of the present teaching. In this illustrated embodiment, the metric-based replacement label determiner 320 proceeds to set the replacement label for correction according to the flags indicating type(s) of data characteristics detected from the profile data. In some embodiments, if flag ALI is True, determined at 480, the replacement flag is set to “full” at 482. If the ALI is False, the processing proceeds to step 487, where if it is determined that flag NI is True, the replacement flag is set to “none” at 489. If flag NI is False as determined at 487, the processing proceeds to 490, where if it is determined that flag IMAR is True, then the replacement label is set to “full” at 492. As discussed herein, with the replacement label with “full” or “none” values, the correction may be carried out by either replacing all measured I-counts using estimated I-counts from the TS model (“full”) or replacing none of them, i.e., retaining all measured I-counts (“none”).

Optionally, in some embodiments, an intermediate correction mode may also be incorporated by setting the replacement label “IS” or intermediate solution. As shown in FIG. 4C, when none of the conditions at 480, 487, and 490 is met, the replacement label is set “IS” at 495, indicating that an intermediate solution for correction is adopted. In this mode of operation, correction with respect to each individual measured I-counts in the profile is handled individually, including deciding whether each individual measure I-count is to be corrected and if so, how to correct each. In the intermediate solution mode, such decisions may be made based on pre-specified conditions evaluated with respect to the value of the measured I-counts. Once the replacement label is set in the process as illustrated in FIG. 4C, corresponding to step 420 in FIG. 4A, the hybrid I-count determiner 260 continues the processing at step 425 in FIG. 4A, as discussed with reference to FIG. 4A.

In some embodiments, the correction scheme in the intermediate solution mode may be implemented using imputation, which determines whether to correct based on preset imputation criteria 340. FIG. 5A illustrates an example of correcting a measured I-count via imputation, in accordance with an exemplary embodiment of the present teaching. In FIG. 5A, curve 500 represents a time series within a 24-hour period with a measured I-count 520 at a particular hour of the period; curve 510 represents time series within the same 24-hour period with an estimated I-count 530 from a corresponding TS model at the same particular hour of the period. In this example, the measured I-count 520 satisfies some preset imputation criteria and is to be corrected, i.e., being replaced using an imputed I-count or the corresponding estimated I-count 530. As can be seen, the measured I-count 520 is a valley point on curve 500 so that the imputation is applied. Other points on curve 500 in this example may not satisfy the imputation criteria so that they are not replaced. That is, each individual measured I-count within the profile is corrected on an individual basis, depending on the assessment of whether each measured I-count value meets certain criteria.

The imputation criteria may be provided based on the need of each application. As discussed herein, the imputation criteria may be formulated based on statistics of the residuals between the measured and estimated I-counts. One example is illustrated in FIG. 1A where a range [−3σ, +3σ] is specified based on standard deviation a of residuals centered around the TS model. This range may serve as a criterion for correction, i.e., any measured I-count outside of this range is to be corrected using the estimated I-count from the TS model. Additional criterion may be added such as the measured I-count being 50% less than that of the TS model. More criteria may be incorporated to define conditions under which a measured I-count is replaced with the estimated I-count from a TS model to generate a corrected I-count.

FIG. 5B is a flowchart of an exemplary process of the intermediate solution unit 330 to correct measured I-counts via imputation, in accordance with an exemplary embodiment of the present teaching. To correct via imputation, residuals computed based on measured and TS model estimated I-counts are received first and standard deviation σ is determined at 540 based on the residuals. To determine whether individual measured I-counts are to be corrected, the imputation criteria 340 are retrieved at 545. From step 550 to step 580, each measured I-count in the profile is processed for correction individually. When next measured I-count is obtained at 550, its value is used to assess, at 555, whether it satisfies the imputation criteria. If the measured I-count does not satisfy the imputation criteria, no correction is needed and the measured I-count is output at 560. The process then proceeds to 575 to determine whether there are more measured I-counts in the profile to be processed.

If the measured I-count meets the imputation criteria, the correction is carried out and the estimated I-count from the TS model is used to replace, at 565, the measured I-count and the corrected I-count is output at 570. It is then determined, at 575, whether there are more measured I-counts in the profile to be processed. If there is no more measured I-count in the profile, the process of intermediate solution unit 330 ends at 580. Otherwise, the process proceeds to step 550 to access the next measured I-count. As seen, in this intermediate solution process, each I-measured I-count in the profile is individually handled for correction so that some of the measured I-counts may be corrected and some may not, depending on their values as compared with the imputation criteria 340. The outputs from the intermediate solution unit 330 are sent to the I-count determiner 350 so that these I-counts are used as the result of the hybrid I-count determiner 260.

The present teaching as described herein for determining corrected I-counts for each site in a hybrid mode may be applied to any application where impression count time series associated with a site displaying content to attract an audience so that inaccurate impression counts due to either failure or specific data characteristics may be adjusted according to an understanding to the nature of the data. In this way, the I-counts derived may be made more accurate on-the-fly based on the present teaching as disclosed herein. In some example applications, the improved I-counts associated with a site displaying an advertisement may be used to determine, e.g., a payment to a host of the site by a corresponding advertiser. In this example, the improved I-counts derived based on the present teaching enable more accurate estimation of the price of displaying advertisements on different types of public display means.

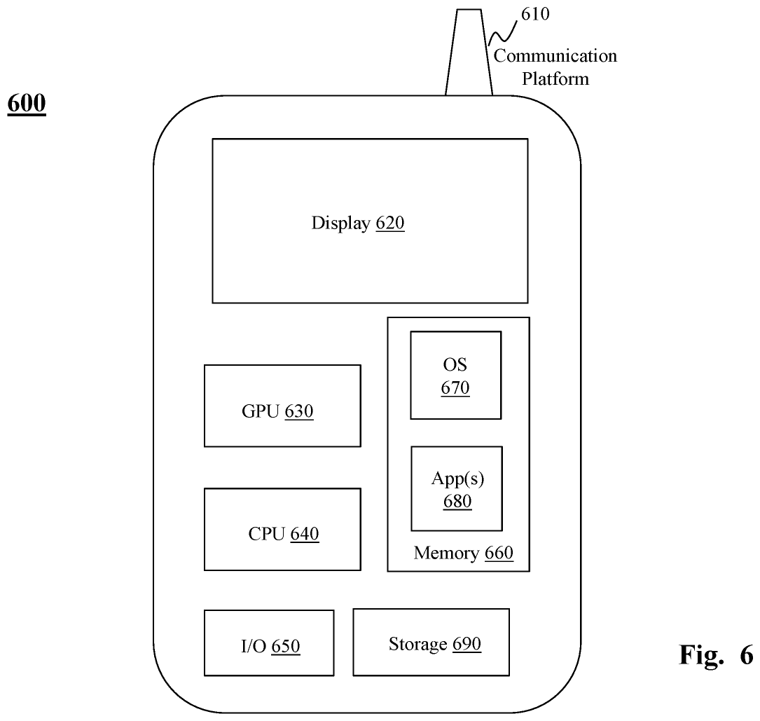

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or a mobile computational unit in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.) and one or more applications 680 may be loaded into memory 660 from storage 690 in order to be executed by the CPU 640. The applications 680 may include a user interface or any other suitable mobile apps for information exchange, analytics, and management according to the present teaching on, at least partially, the mobile device 600. User interactions, if any, may be achieved via the I/O devices 650 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

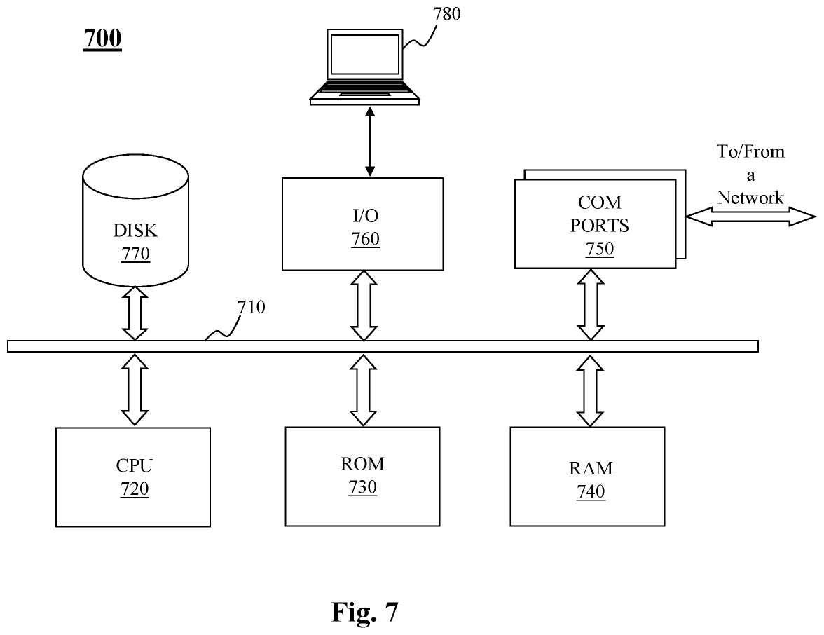

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information processing and analytical method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 800 also includes an I/O component 760, supporting input/output flows between the computer and other components therein such as user interface elements 880. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
obtaining measured impression counts (MI-counts) over a period of time associated with a site displaying content that gives rise to impressions;
establishing a forecasting time series (TS) model based on the MI-counts;
calculating a plurality of metrics for a profile corresponding to a sub-range of the period of time based on MI-counts within the profile;
detecting one or more types of data characteristics exhibited in the profile based on the plurality of metrics;
determining a hybrid correction operation to be applied to each of the MI-counts in the profile according to the detected one or more types of data failure;
generating corrected MI-counts for the profile based on the MI-counts in the profile and the forecasting TS model in accordance with the determined hybrid correction operation; and
providing the corrected MI-counts for determining a level of viewership of the content at the site based on the corrected MI-counts.

2. The method of claim 1, wherein the forecasting TS model is established based on MI-counts over the period of time excluding a subset of the MI-counts in the profile.

3. The method of claim 1, wherein the one or more types of data characteristics include:
a first type of data characteristics with impressions missing at random;
a second type of data characteristics with noisy impressions; and
a third type of data characteristics with anomalously low impressions.

4. The method of claim 3, wherein the plurality of metrics include:
a first group of statistical metrics for capturing the first type of data characteristics with impressions missing at random;
a second group of frequency domain metrics for capturing the second type of data characteristics with noisy impressions; and
a third group of statistical metrics for capturing the third type of data characteristics with anomalously low impressions.

5. The method of claim 3, wherein the step of determining a hybrid correction operation comprises:
if the first type of data characteristics is detected, the replacement label is set to a first label;
if the third type of data characteristics is detected, the replacement label is set to the first label; and
if the second type of data characteristics is detected, the replacement label is set to a second label, wherein
the first label indicates that all the MI-counts in the subset of profile are replaced with corresponding I-counts estimated based on the forecasting TS model, and
the second label indicates that none of the MI-counts in the subset of the profile are replaced.

6. The method of claim 5, further comprising setting, when the replacement label is set neither the first nor the second label, the replacement label to a third label.

7. The method of claim 6, further comprising:
carrying out, when the replacement label is set to be the third label, the hybrid correction operation with respect to each of the MI-counts in the profile by:
replacing the MI-count in the profile with a corresponding I-count estimated from the forecasting TS model if the MI-count in the profile satisfies a condition defined based on statistics of residuals between the MI-counts in the period of time and corresponding I-counts estimated from the forecasting TS model; and
retaining the MI-count in the profile if the MI-count in the profile does not satisfy the condition.

8. A machine readable and non-transitory medium having information recorded thereon, wherein the information, when read by the machine, causes the machine to perform the following steps:
obtaining measured impression counts (MI-counts) over a period of time associated with a site displaying content that gives rise to impressions;
establishing a forecasting time series (TS) model based on the MI-counts;
calculating a plurality of metrics for a profile corresponding to a sub-range of the period of time based on MI-counts within the profile;
detecting one or more types of data characteristics exhibited in the profile based on the plurality of metrics;
determining a hybrid correction operation to be applied to each of the MI-counts in the profile according to the detected one or more types of data failure;
generating corrected MI-counts for the profile based on the MI-counts in the profile and the forecasting TS model in accordance with the determined hybrid correction operation; and
providing the corrected MI-counts for determining a level of viewership of the content at the site based on the corrected MI-counts.

9. The medium of claim 8, wherein the forecasting TS model is established based on MI-counts over the period of time excluding a subset of the MI-counts in the profile.

10. The medium of claim 8, wherein the one or more types of data characteristics include:
a first type of data characteristics with impressions missing at random;
a second type of data characteristics with noisy impressions; and
a third type of data characteristics with anomalously low impressions.

11. The medium of claim 10, wherein the plurality of metrics include:
a first group of statistical metrics for capturing the first type of data characteristics with impressions missing at random;
a second group of frequency domain metrics for capturing the second type of data characteristics with noisy impressions; and
a third group of statistical metrics for capturing the third type of data characteristics with anomalously low impressions.

12. The medium of claim 10, wherein the step of determining a hybrid correction operation comprises:
if the first type of data characteristics is detected, the replacement label is set to a first label;
if the third type of data characteristics is detected, the replacement label is set to the first label; and
if the second type of data characteristics is detected, the replacement label is set to a second label, wherein
the first label indicates that all the MI-counts in the subset of the profile are replaced with corresponding I-counts estimated based on the forecasting TS model, and
the second label indicates that none of the MI-counts in the subset of the profile is replaced.

13. The medium of claim 12, wherein the information, when read by the machine, further causes the machine to perform the step of setting, when the replacement label is set neither the first nor the second label, the replacement label to a third label.

14. The medium of claim 13, wherein the information, when read by the machine, further causes the machine to perform the step of carrying out, when the replacement label is set to be the third label, the hybrid correction operation with respect to each of the MI-counts in the profile by:
replacing the MI-count in the profile with a corresponding I-count estimated from the forecasting TS model if the MI-count in the profile satisfies a condition defined based on statistics of residuals between the MI-counts in the period of time and corresponding I-counts estimated from the forecasting TS model; and
retaining the MI-count in the profile if the MI-count in the profile does not satisfy the condition.

15. A system, comprising:
a market I-count generation unit implemented by a processor and configured for obtaining measured impression counts (MI-counts) over a period of time associated with a site displaying content that gives rise to impressions;
a forecasting TS model generator implemented by a processor and configured for establishing a forecasting time series (TS) model based on the MI-counts;
a profile metrics determiner implemented by a processor and configured for calculating a plurality of metrics for a profile corresponding to a sub-range of the period of time based on MI-counts within the profile;
a metric-based replacement label determiner implemented by a processor and configured for
detecting one or more types of data failure exhibited in the profile based on the plurality of metrics, and
determining a hybrid correction operation to be applied to each of the MI-counts in the profile according to the detected one or more types of data characteristics; and
an I-count determiner implemented by a processor and configured for
generating corrected MI-counts for the profile based on the MI-counts in the profile and the forecasting TS model in accordance with the determined hybrid correction operation, and
providing the corrected MI-counts for determining a level of viewership of the content at the site based on the corrected MI-counts.

16. The system of claim 15, wherein the forecasting TS model is established based on MI-counts over the period of time excluding a subset of the MI-counts in the profile.

17. The system of claim 15, wherein the one or more types of data characteristics include:
a first type of data characteristics with impressions missing at random;
a second type of data characteristics with noisy impressions; and
a third type of data characteristics with anomalously low impressions.

18. The system of claim 17, wherein the plurality of metrics include:
a first group of statistical metrics for capturing the first type of data characteristics with impressions missing at random;
a second group of frequency domain metrics for capturing the second type of data characteristics with noisy impressions; and
a third group of statistical metrics for capturing the third type of data characteristics with anomalously low impressions.

19. The system of claim 17, wherein the step of determining a hybrid correction operation comprises:
if the first type of data characteristics is detected, the replacement label is set to a first label;
if the third type of data characteristics is detected, the replacement label is set to the first label; and
if the second type of data characteristics is detected, the replacement label is set to a second label, wherein
the first label indicates that all the MI-counts in the subset of the profile are replaced with corresponding I-counts estimated based on the forecasting TS model, and
the second label indicates that none of the MI-counts in the subset of the profile is replaced.

20. The system of claim 19, wherein the I-count determiner is further configured for
setting, when the replacement label is set neither the first nor the second label, the replacement label to a third label; and
carrying out the hybrid correction operation with respect to each of the MI-counts in the profile by:
replacing the MI-count in the profile with a corresponding I-count estimated from the forecasting TS model if the MI-count in the profile satisfies a condition defined based on statistics of residuals between the MI-counts in the period of time and corresponding I-counts estimated from the forecasting TS model, and
retaining the MI-count in the profile if the MI-count in the profile does not satisfy the condition.
